(19) United States
(12) Patent Application Publication
(10) Pub. No.: US 2013/0309450 A1
(43) Pub. Date: Nov. 21, 2013

(54) SUPERHYDROPHOBIC SURFACES

(71) Applicants: Michelle Khine, Irvine, CA (US); Lauren Freschauf, Mission Viejo, CA (US); Jolie McLane, Newport Beach, CA (US)

(72) Inventors: Michelle Khine, Irvine, CA (US); Lauren Freschauf, Mission Viejo, CA (US); Jolie McLane, Newport Beach, CA (US)

(21) Appl. No.: 13/891,104

(22) Filed: May 9, 2013

Related U.S. Application Data
(60) Provisional application No. 61/646,177, filed on May 11, 2012.

(51) Int. Cl. B08B 17/06; B05D 3/06

(52) U.S. Cl. CPC B08B 17/065; B05D 3/068
USPC 428/141; 427/535

(57) ABSTRACT

Provided are methods for preparing a mold for making a superhydrophobic surface, comprising contacting a surface of a thermoplastic material with a plasma; coating the surface with a metal; and heating the thermoplastic material to shrink the surface such that the coated metal forms a texture. Also provided are methods of preparing a superhydrophobic surface, as well as a superhydrophobic surface that includes a hydrophilic portion prepared by plasma treatment.

### CROSS REFERENCE TO RELATED APPLICATIONS

This application claims the benefit under 35 U.S.C. §119(e) of U.S. Provisional Application Ser. No. 61/646,177, filed May 11, 2012, the content of which is incorporated by reference in its entirety.

### STATEMENT OF GOVERNMENT RIGHTS

This invention was made with Government support under Contract No. N66001-10-1-4003 awarded by Defense Advanced Research Projects Agency (DARPA). The U.S. Government has certain rights in this invention.

### BACKGROUND

Wetting, or wettability, of a surface is an important trait in materials for modern technology which is affected by the chemical and structural composition of a material. The need for hydrophobic coatings is especially of interests in many industries such as windshield wipers, cell phone covers, ship hulls, and microfluidic channels. Water forms into droplets on hydrophobic surfaces when the adhesive forces within the water are greater than the cohesive forces between the surface of the material and the water.

The criteria which qualify a surface as super-hydrophobic are a water contact angle greater than 150° and a low sliding angle less than 5°. The water contact angle is a measurement of the inner angle formed by the surface of the material and the water droplet. While it may seem that is this the most important factor in wettability, the more pivotal measurement is that of the sliding angle. Sliding angle is a measurement of the angle at which the water begins to slide across the surface.

When resistance to sliding or even inversion of the water droplet does not cause separation from the surface then contact angle hysteresis is occurring. Hysteresis is a condition in which the rear angle and the front angle of the water droplet are unequal. In this case the rear angle is less than that in the front.

With both a large contact angle and a low sliding angle, a material can be made into an antibacterial surface because the extreme hydrophobic effects will disallow for bacterial attachment. The spread of bacteria is a common problem and is the main source of health associated infections. In 2009, such health associated infections cost the healthcare industry $28-45 billion and ranged from food poisoning to septicemia, often leading to extensive hospital care and even death. Bacterial exposure can occur during surgical procedures or can be transferred patient-to-patient from infected hospital surfaces. Hospitals are a major source of bacterial spread, but everyday facilities also act as distributors of bacterial disease. Flores et al. has shown that public restrooms house at least nineteen strains of bacteria, ranging from skin, gut, and soil sources that can be transferred by touch. Therefore, there is a growing demand for reliable antibacterial surfaces to combat this common occurrence of contamination.

Currently, there are fabrication methods for antibacterial reagents and structurally modified antibacterial surfaces. Silver nanoparticles have been used as a bacterial growth inhibitor as the heavy metals disrupt and inactivate the proteins in bacteria, preventing growth. Functional groups on self-assembled gold monolayers have also been used to decrease bacterial motility and attachment, preventing cell adherence, growth of bacteria on surfaces, and the formation of biofilms. It has been shown that high molecular weights of chitosan inhibit gram-positive bacteria such as Staphylococcus aureus due to lack of nutrient adsorptions whereas low molecular weights of chitosan inhibit gram-negative bacteria such as E. coli due to a disturbed metabolism. Chemically modified superhydrophobic surfaces have also been shown to inhibit bacterial growth because of the low surface energy and minimal contact with the surface for bacterial adhesion.

While many antibacterial reagents and chemicals effectively inhibit the growth of bacteria, they can lead to bacterial resistance and become ineffective over time. Purely structural antibacterial surfaces, however, do not induce bacterial resistance and are therefore ideal for preventing the spread of infectious bacteria. Superhydrophobic surfaces have become particularly desirable as stable antibacterial surfaces because of their self-cleaning and water resistant properties.

Antibacterial coatings can be used to protect the body from contamination of dental implants, titanium implants such as hip replacements, and even in textiles. Antibacterial treatments seek to eliminate the possibility of growth through three separate methods; adhesion resistance, contact killing, and biocide leaching.

A super-hydrophobic surface would utilize the first method of adhesion resistance from bacteria in suspension. This type of surface is capable of antibacterial properties because of the decreased contact that the suspended bacteria would otherwise have with the surface. An advantage to applying a super-hydrophobic coating to a material is that the bulk properties can be preserved. Adding functional groups to promote contact killing can be difficult depending on the chemistry of the bulk material. Cytotoxic compounds for biocide leaching may adversely affect desired bulk materials of the device. However, the creation of a rapid fabrication process for a simple hydrophobic coating will create the desired antibacterial properties effectively.

### SUMMARY

One embodiment of the disclosure provides a method for preparing a mold for making a superhydrophobic surface, comprising contacting a surface of a thermoplastic material with a plasma; coating the surface with a metal; and heating the thermoplastic material to shrink the surface such that the coated metal forms a texture.

In some aspects, the method further comprises creating a mirrored texture on a surface of a hydrophobic material, using the textured metal surface of the thermoplastic material as a mold.

In some aspects, the plasma is oxygen plasma.

In some aspects, the contacting with the plasma is from about 10 seconds to about 2 minutes in duration, or from about 15 seconds to about 60 seconds in duration, or from about 20 seconds to about 40 seconds, or about 30 seconds.

In some aspects, the metal comprises silver. In some aspects, the metal comprises gold. In some aspects, the metal comprises both silver and gold. In some aspects, the coating is from about 10 nm to about 200 nm in thickness, or from about 30 nm to about 90 nm, or from about 45 nm to about 75 nm, or about 60 nm.

In some aspects, the heating is carried out in a temperature from about 100° C. to about 200° C. In some aspects, the heating is carried out at from about 100° C. to about 120° C. for about 3-10 minutes followed by heating at about 150° C. to about 170° C. for about 3-10 minutes.

In some aspects, the surface of the thermoplastic material is shrunk by at least 60%. In some aspects, the texture has an average height from about 2 μm to about 4 μm.

In some aspects, the thermoplastic material comprises a high molecular weight polymer, polyolefin, polyethylene, acrylonitrile butadiene styrene (ABS), acrylic, celluloid, cellulose acetate, ethylene-vinyl acetate (EVA), ethylene vinyl alcohol (EVAL), fluoroplastics (PTFEs, including FEP, PFA, CTFE, ECTFE, ETFE), ionomers kydex, a trademarked acrylic/PVC alloy, liquid crystal polymer (LCP), polyacetal (POM or Acetal), polyacrylates (Acrylic), polyacrylonitrile (PAN or Acrylonitrile), polyamide (PA or Nylon), polyamide-imide (PAI), polyaryletherketone (PAEK or Ketone), polybutadiene (PBD), polybutylene (PB), polybutylene terephthalate (PBT), polyethylene terephthalate (PET), Polycyclohexylene Dimethylene Terephthalate (PCT), polycarbonate (PC), polyhydroxyalkanoates (PHAs), polyketone (PK), polyester polyethylene (PE), polyetheretherketone (PEEK), polyetherimide (PEI), polyethersulfone (PES), polysulfone polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC) or spectralon. In some aspects, the thermoplastic material comprises polyolefin.

In some aspects, the hydrophobic material comprises polydimethylsiloxane (PDMS).

In some aspects, the method further comprises subjecting a portion of the surface of the hydrophoblic material to a plasma treatment, such that the portion becomes temporally hydrophilic.

Also provided, in one embodiment, is a superhydrophobic surface prepared by the method of the above embodiments. In some aspects, the superhydrophobic surface has an average water contact angles above about 120° and an average water sliding angle below about 10°.

Also provided, in some aspects, is a superhydrophobic surface comprising a hydrophilic portion prepared by the method of the above embodiments.

### BRIEF DESCRIPTION OF THE FIGURES

FIG. 1A-B show an example of contact angle measurement method using digital photography.

FIG. 2A-E illustrate a brief process flow of this fabrication method paired with water contact angle shots for each step.

FIG. 3A-C present scanning electron microscope (SEM) images of PDMS casts depicting the roughness translated directly from the shrunk, bimetallic PO mold into the PDMS.

FIG. 4 presents a chart showing that the structural modification of the surface greatly enhances the hydrophobicity.

FIG. 5A-F show a tilted sample at about 5° where the water droplet briefly touches the surface, then recedes back onto the dropper.

FIG. 6A-D show SEM images of the superhydrophobic PDMS and flat PDMS with and without E. coli cultured for 24 hours.

FIG. 6E shows the spectrophotometer analysis of the E. coli present on the flat and superhydrophobic PDMS.

FIG. 7A-D show superhydrophobic PDMS having a hydrophilic area.

FIG. 8 illustrates a process flow of the superhydrophobic substrates formed from shrink film paired with their respective contact angle (CA).

FIG. 9A-D show top down SEM images and AFM of the structurally modified surfaces' multiscale structures taken.

FIG. 10A-B include graphs depicting CA and SA for the structurally modified surfaces compared to flat.

FIG. 11A-B show that superhydrophobic surfaces exhibited a significantly reduced amount of bacterial growth over flat surfaces.

### DETAILED DESCRIPTION

### Definitions

As used herein, certain terms may have the following defined meanings

As used in the specification and claims, the singular form “a,” “an” and “the” include plural references unless the context clearly dictates otherwise.

As used herein, the term “comprising” is intended to mean that the compositions and methods include the recited elements, but do not exclude others. “Consisting essentially of” when used to define compositions and methods, shall mean excluding other elements of any essential significance to the combination when used for the intended purpose. Thus, a composition consisting essentially of the elements as defined herein would not exclude trace contaminants or inert carriers. “Consisting of” shall mean excluding more than trace elements of other ingredients and substantial method steps for preparing the intended device. Embodiments defined by each of these transition terms are within the scope of this invention.

All numerical designations, e.g., pH, temperature, time, concentration, and molecular weight, including ranges, are approximations which are varied (+) or (−) by increments of 0.1. It is to be understood, although not always explicitly stated that all numerical designations are preceded by the term “about”. It also is to be understood, although not always explicitly stated, that the reagents described herein are merely exemplary and that equivalents of such are known in the art.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above.

A “thermoplastic material” is intended to mean a plastic material which shrinks upon heating or upon release of prestress such as a stress created by stretching. In one aspect, the thermoplastic materials are those which shrink uniformly without distortion. The shrinking can be either bi-axially (isotropic) or uni-axial (anisotropic). Suitable thermoplastic materials for inclusion in the methods of this invention include, for example, polyolefin, polyethylene, high molecular weight polymers such as acrylonitrile butadiene styrene (ABS), acrylic, celluloid, cellulose acetate, ethylene-vinyl acetate (EVA), ethylene vinyl alcohol (EVAL), fluoroplastics (PTFEs, including FEP, PFA, CTFE, ECTFE, ETFE), ionomers kydex, a trademarked acrylic/PVC alloy, liquid crystal polymer (LCP), polyacetal (POM or Acetal), polyacrylates (Acrylic), polyacrylonitrile (PAN or Acrylonitrile), polyamide (PA or Nylon), polyamide-imide (PAI), polyaryletherketone (PAEK or Ketone), polybutadiene (PBD), polybutylene (PB), polybutylene terephthalate (PBT), polyethylene terephthalate (PET), Polycyclohexylene Dimethylene Terephthalate (PCT), polycarbonate (PC), polyhydroxyalkanoates (PHAs), polyketone (PK), polyester polyethylene (PE), polyetheretherketone (PEEK), polyetherimide (PEI), polyethersulfone (PES), polysulfone polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC) and spectralon.

In some aspects, the thermoplastic material encompasses polyolefin. A polyolefin is a polymer produced from a simple olefin (also called an alkene) as a monomer. For example, polyethylene is the polyolefin produced by polymerizing the olefin ethylene. Polypropylene is another common polyolefin which is made from the olefin propylene.

In some aspects, the thermoplastic material encompasses shape memory polymers (SMPs). SMPs are polymeric smart materials that have the ability to return from a deformed state (temporary shape) to their original (permanent) shape induced by an external stimulus (trigger), such as temperature change.

Commercially available thermoplastic materials include, without limitation, “Shrinky-Dink” and porous films such as Solupore®. Shrinky-Dink is a commercial thermoplastic which is used a children's toy. Solupore® is available from Lydall, Inc. of Manchester, Conn.

### Methods for Preparing a Superhydrophobic Surface

One embodiment of the disclosure provides a method for preparing a superhydrophobic surface. In one embodiment, a mold is prepared. The method of preparing the mold entails, in one embodiment, contacting a surface of a thermoplastic material with a plasma; coating the surface with a metal; and heating the thermoplastic material to shrink the surface such that the coated metal forms a texture. After the mold is prepared, the mold can be used to create a mirrored texture on a surface of a second material, thereby creating a superhydrophobic surface. In some aspects, the second material is a hydrophobic material.

Plasmas can be prepared with methods known in the art and can vary depending on availability of sources. In one embodiment, the plasma is oxygen plasma, helium plasma, or hydrogen plasma. In a particular embodiment, the plasma is oxygen plasma.

In some aspects, the contacting with the plasma is from about 10 seconds to about 2 minutes in duration, or from about 15 seconds to about 60 seconds in duration, or from about 20 seconds to about 40 seconds, or about 30 seconds. In some aspects, the plasma treatment is for at least about 10, 15, 20, 25, 30, 35, 40, 45, 50, 55 or 60 seconds. In some aspects, the plasma treatment is no longer than about 120, 110, 100, 90, 80, 70, 60, 55, 50, 45, 40, 35 or 30 seconds.

In some aspects, the metal comprises silver. In some aspects, the metal comprises gold. In some aspects, the metal comprises both silver and gold.

In some aspects, the coating is from about 10 nm to about 200 nm in thickness, or from about 30 nm to about 90 nm, or from about 45 nm to about 75 nm, or about 60 nm. In some aspects, the coating is at least about 10 nm, 20 nm, 30 nm, 40 nm, 50 nm, 60 nm, 70 nm, 80 nm, 90 nm, or 100 nm in thickness. In some aspects, the coating has a thickness less than about 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 50 nm, 40 nm, or 30 nm.

In some aspects, the heating is carried out in a temperature from about 100° C. to about 200° C. In some aspects, the heating temperature is at least about 100, 110, 120, 130, 140, 150, or 160° C. In some aspects, the heating temperature is not higher than about 200, 190, 180, 170, 160, 150, or 140° C.

In some aspects, the heating is carried out at from about 100° C. to about 120° C. for about 3-10 minutes. In some aspects, the first heating is followed by heating at about 150° C. to about 170° C. for about 3-10 minutes. In some aspects, the total heating time is less than 10, 9, 8, 7, 6, or 5 minutes. In some aspects, the total heating time is at least about 2, 3, 4, 5, 6, 7, 8, 9 or 10 minutes.

In some aspects, the surface of the thermoplastic material is shrunk by at least about 60%. In some aspects, the thermoplastic material is shrunk by at least about 65%, 70%, 75%, 80%, 85%, or 90%.

In some aspects, the texture has an average height from about 1 μm to about 5 μm. In some aspects, the texture has an average height of at least about 1 μm, or alternatively 1.5, 2, 2.5, 3, 3.5 or 4 μm. In some aspects, the texture has an average height that is not higher than about 5 μm, or alternatively about 4.5, 4, 3.5, 3 or 2.5 μm.

In some aspects, the thermoplastic material comprises a high molecular weight polymer, polyolefin, polyethylene, acrylonitrile butadiene styrene (ABS), acrylic, celluloid, cellulose acetate, ethylene-vinyl acetate (EVA), ethylene vinyl alcohol (EVAL), fluoroplastics (PTFEs, including FEP, PFA, CTFE, ECTFE, ETFE), ionomers kydex, a trademarked acrylic/PVC alloy, liquid crystal polymer (LCP), polyacetal (POM or Acetal), polyacrylates (Acrylic), polyacrylonitrile (PAN or Acrylonitrile), polyamide (PA or Nylon), polyamide-imide (PAI), polyaryletherketone (PAEK or Ketone), polybutadiene (PBD), polybutylene (PB), polybutylene terephthalate (PBT), polyethylene terephthalate (PET), Polycyclohexylene Dimethylene Terephthalate (PCT), polycarbonate (PC), polyhydroxyalkanoates (PHAs), polyketone (PK), polyester polyethylene (PE), polyetheretherketone (PEEK), polyetherimide (PEI), polyethersulfone (PES), polysulfone polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC) or spectralon. In some aspects, the thermoplastic material comprises polyolefin.

In some aspects, the hydrophobic material comprises polydimethylsiloxane (PDMS).

### Preparation of a Microfluidic Device

In some aspects, the method further comprises subjecting a portion of the surface of the hydrophobic material to a plasma treatment, such that the portion becomes temporally hydrophilic. Such a hydrophilic portion, if prepared in the form of a micro channel, makes the overall superhydrophobic surface a microfluidic device.

In some aspects, the hydrophilic portion comprises a channel that is in micro or nano scale. In some aspect, the channel is from about 10 nm to about 10 μm in width. In some aspects, the channel has a width that is at least about 10, 50, 100, 150, 200, 300, 400, or 500 nm. In some aspects, the channel has a width that is not greater than about 10 μm, 5 μm, 1 μm, 900 nm, 800 nm, 700 nm, 600 nm, 500 nm, 400 nm, 300 nm, 200 nm, 150 nm, 100 nm or 50 nm.

### Prepared Devices

The present disclosure also provides, in some embodiments, superhydrophobic surfaces or microfluidic devices prepared by the method of the above embodiments.

In some aspects, the superhydrophobic surface has an average water contact angles above about 120°. In some aspects, the superhydrophobic surface has an average water contact angles above about 130°, 140°, 145°, 150°, 155°, 160°, 165° or 170°. In some aspects, the superhydrophobic surface has an average water contact angles below about 175°, 170°, 165°, 160°, 155° or 150°.

In some aspects, the superhydrophobic surface has an average water sliding angle below about 10°, or alternatively below about 9°, 8°, 7°, 6°, 5°, 4°, 3° or 2°.

### EXPERIMENTAL EXAMPLES

### Example 1

This example presents a robust, rapid, and reproducible superhydrophobic surface with hierarchal nano- and microscale structures molded into polydimethylsiloxane (PDMS). This method involves a structural modification free of chemical additives leading to its inherent consistency over time, thermal stress, and successive remolding from the same master mold. Because the mold is made from shrink-wrap film, it is compatible with large plastic roll to roll manufacturing and scale-up. Further, selectively hydrophilic regions can be easily integrated into the superhydrophobic PDMS for novel microfluidics.

The surface tension created between water and a surface can be calculated with the use of Young's equation where the three interfaces, solid-liquid, solid-vapor, and liquid-vapor, describe the resulting water contact angle (CA). In particular, as the liquid-solid surface tension increases, the water contact angle increases due to less physical contact. According to Wenzel's theory, the so called roughness factor, determined by a ratio of the actual surface to the geometric surface, would cause a strong interaction between the liquid and solid phases. Thus water would fill the minute gaps created on roughened surfaces resulting in stronger interactions. However, another model was developed by Cassie and Baxter, where a heterogeneous surface is better described to create air pockets between the water and surface. This increase in liquid-solid surface tension is the primary key to the superhydrophobic phenomenon or lotus effect.

Superhydrophobicity is achieved when the water contact angle exceeds 150° and the sliding angle (SA) is reduced to less than 10°. The minimal surface contact and ease of movement exhibited by water on superhydrophobic surfaces can be attributed to the creation of a heterogeneous surface containing nano- and microscale structures. To produce such an effect this example performed a structural modification to PDMS. The resulting surface has proven to produce consistent water contact angle measurements over time, successive casting, and at elevated temperatures.

### Methods

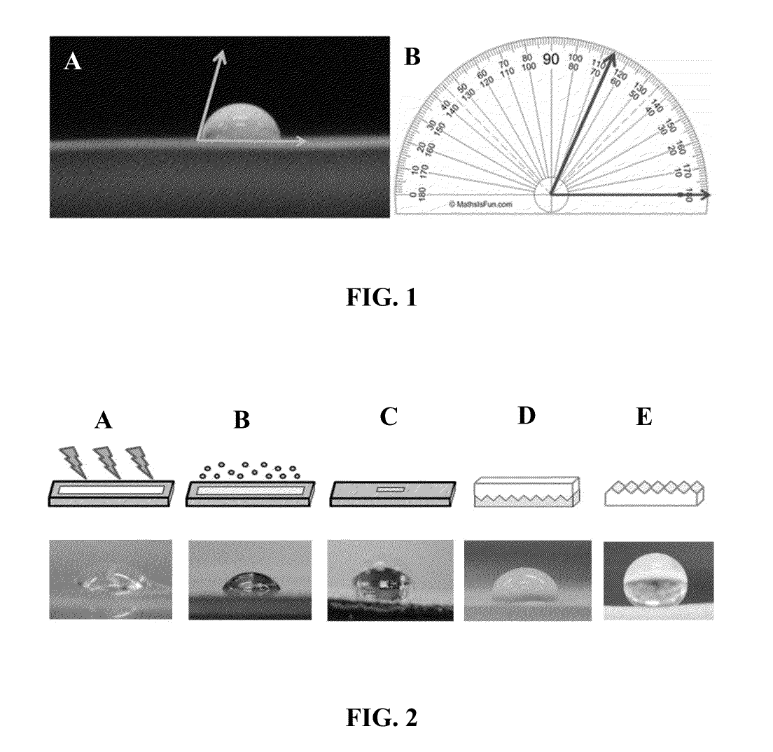

The contact angles were measured on a computer with a photo from a digital camera. By zooming in on the picture, super imposing lines over the photo, and using a picture of a protractor, the contact angle can be quickly measured with relative accuracy (FIG. 1).

By utilizing a new shrink method, PDMS molds were made from shrink film, polyolefin (PO). The PO was initially adhered to a glass slide with the use of adhesive (Walser) to prevent movement during treatment. A pretreatment with oxygen plasma for 30 seconds was performed to temporarily increase the surface energy of the PO for better adhesion of metal. A sputter coating of a 60 nm layer of silver and gold followed. After the bimetallic coating, the film is heated to 115° C. and maintained at that temperature for 5 minutes. It is further heated to 160° C. and maintained at that temperature for an additional 5 minutes to complete the shrinking process. This causes the stiffer metal to shrink and subsequently buckle, creating extremely rough, high aspect and multi-scale structures. FIG. 2A-E depicts a brief process flow of this fabrication method paired with water contact angle shots for each step.

As shown in FIG. 2, the superhydrophobic PDMS casts formed from shrink film (upper) are paired with their respective water contact angle shots (bottom). (A) PO film adhered to a glass slide is plasma treated with oxygen; (B) The treated PO film is sputter coated with 60 nm of silver and 60 nm of gold; (C) PO film is shrunk at 160° C.; (D) Shrunk PO film is removed from the glass slide and PDMS is poured over it for casting (paired photo features flat PDMS); (E) Superhydrophobic PDMS cast is removed from shrunk PO.

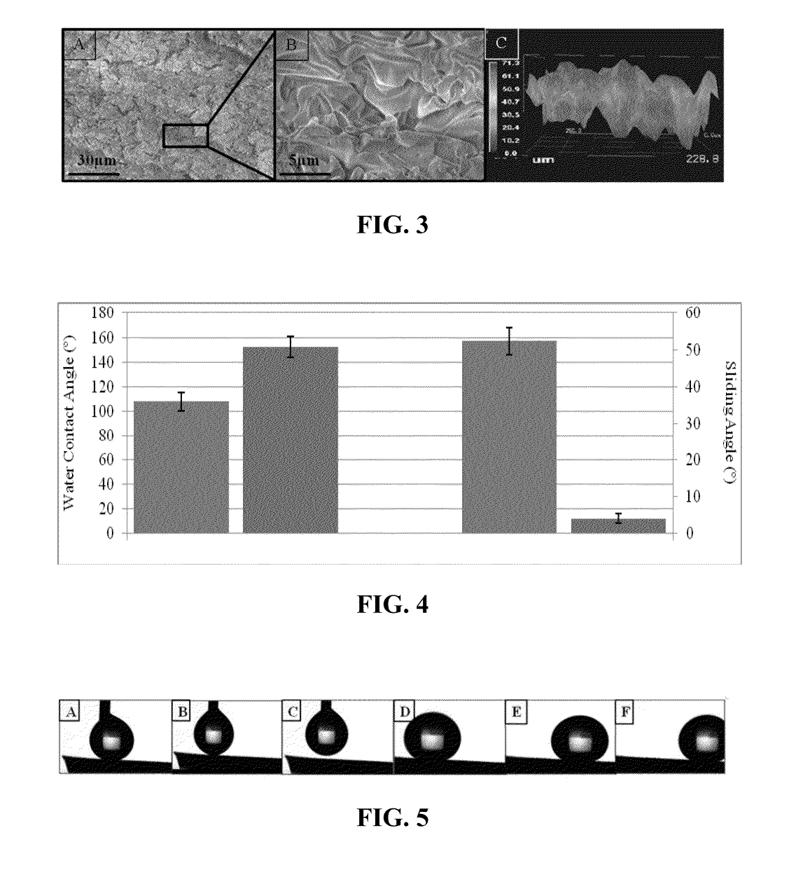

The heterogeneous nano- and microstructures of the PDMS cast were analyzed using a scanning electron microscope (SEM) (Hitachi S-4700-2 FESEM) and a Keyence Digital Microscope (KDM) (Keyence VHX-100) shown in FIG. 3A-C. These SEM images of the PDMS casts depict the roughness translated directly from the shrunk, bimetallic PO mold into the PDMS. Nanostructures can be seen on the surface of the microstructures of the PDMS leading to the enhanced hydrophobicity. Further visualization of morphology and height was achieved using the KDM where it is shown that the height range of the microstructures is about 70 μm. FIG. 3A presents a SEM image of the superhydrophobic nano- and micro-features in PDMS from a top down view. FIG. 3B includes a magnified top down SEM view. FIG. 3A is a height profile taken with a KDM.

The superhydrophobic properties of the PDMS cast and flat PDMS were performed with CA and SA measurements. CA measurements were taken with a contact angle meter (Drop Shape Analysis System DSA100, KRUSS) 4 weeks post fabrication while preliminary measurements were taken using a publicly available drop analysis program within 1 day of separation of the PDMS cast from the bimetallic, shrunk PO mold. The SA measurements were performed using a tool clamp with a 90° rotational arm.

### Results

With this method this example was able to induce superhydrophobic properties on PDMS through a cast and molding method. The bimetallic layer deposited on the preshrunk PO mold provided the initial necessary mismatch in stiffness during the shrinking process to create highly structured features after shrinking is complete. When casted with PDMS, the bimetallic, shrunk PO mold transfers its physical shape.

This produced heterogeneous roughening on the PDMS surface enhancing its natural hydrophobic properties. The resulting CA averaged above 150° with a maximum of 167.1° measured with the KRUSS system and the average sliding angle was below 5° with a minimum of less than 2°, well within the standard criteria of superhydrophobic surfaces.

FIG. 4 summarizes these findings compared to flat PDMS where it is evident that the structural modification of the surface greatly enhances the hydrophobicity. These CA measurements were taken 4 weeks post-fabrication and when compared to initial measurements taken within 24 hours there was a negligible difference. FIG. 4 includes a graph depicting water contact angle (left) and sliding angle (right) of flat PDMS (left half) and the fabricated superhydrophobic PDMS (right half).

FIG. 5 shows a tilted sample at about 5° where the water droplet briefly touches the surface, then recedes back onto the dropper. Once placed on the surface, the low sliding angle causes the droplet to immediately roll out of view. A droplet being placed on the surface retracts to the dropper (FIG. 5A-C); A droplet rolling off the same surface immediately after placement (FIG. 5D-F).

The consistency attributed to this method is due in part to the natural properties of PDMS and to the method of our design. With our cast and mold method, the surface of the PDMS becomes superhydrophobic due to the highly intercut structures passed on from mold to cast. We created multiple casts from the same molds and found that over the course of three molds the water contact angle remained consistently above 150° though after the fourth mold the average value dipped to about 148°±7.5°. It should be noted, however, that the structures produced are heterogeneous in design leading to some unavoidable variability in values. The thermal stability of these casts were also investigated and proved to remain stable across a range of heat exposure. This thermal testing was done with the use of a hot plate with temperatures up to 100° C. Samples were placed on the plate at 10° intervals and allowed to acclimate to the indicated temperature over the course of 5 minutes with a 5 μL water droplet. The CA was taken using a drop analysis program.

Antimicrobial applications were analyzed through the addition of E. coli in suspension with lysogeny broth (LB) to both flat and superhydrophobic PDMS surfaces. Following 24 hour incubation, SEM images and spectrophotometry absorbances were taken to determine the attachment of E. coli.

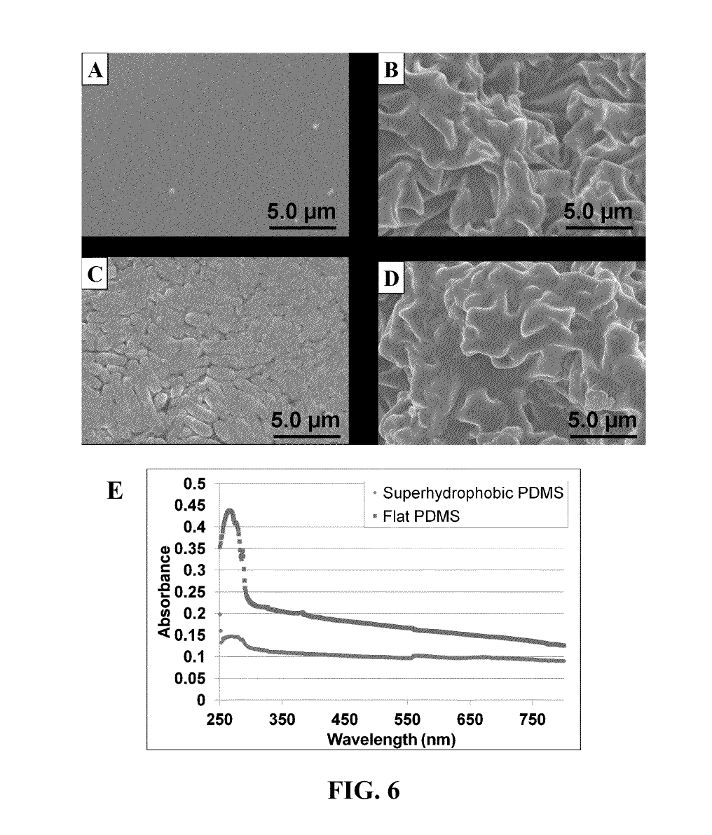

FIG. 6A-D show SEM images of the superhydrophobic PDMS and flat PDMS with and without E. coli cultured for 24 hours. It is clear from C that the E. coli proliferate on the flat PDMS but do not on the superhydrophobic PDMS as seen in D. FIG. 6E depicts the spectrophotometer analysis of the E. coli present on the flat and superhydrophobic PDMS. The difference between the absorbance values was taken of both E. coli infected surfaces and clean surfaces to determine presence of E. coli.

In addition to superhydrophobicity, this example was able to create temporary chemically induced hydrophilic patterning on the surface. This was performed using a post fabrication oxygen plasma treatment for 30 seconds through a negative mask made in house. The resulting section of PDMS is exposed to oxygen plasma which charges the surface of the PDMS and allows water to enter the rough structures on the surface. FIG. 6 demonstrates this effect while exhibiting the retention of superhydrophobic regions protected by the mask against the oxygen plasma treatment. The ability to induce temporary hydrophilic channels presents the opportunity for these superhydrophobic PDMS platforms to be utilized in such methods as open channel microfluidics. The temporary nature of this hydrophilic channel also allows for the superhydrophobic PDMS platform to be used multiple times with different masking patterns. Elongated lifetime of the hydrophilic channel may be achieved through a thermal aging method. This further adds to the versatility of our method for producing superhydrophobic PDMS.

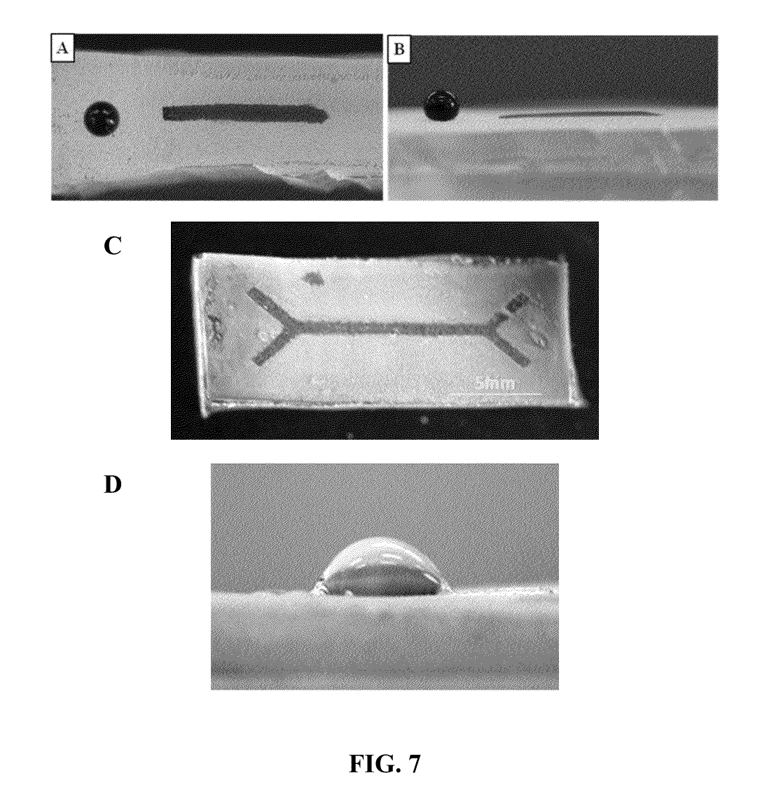

As shown in FIG. 7A-B, selective oxygen plasma treatment results in temporary, patterned hydrophilic regions (blue line) while retaining superhydrophobicity (gray drop). (A) A top down view; (B) A profile view. Using this method, a patterned PDMS mold can be prepared, such as having a microfluidic channel (FIG. 7C), where in the channel a water drop has a small contact angle (FIG. 7D).

This example presented a new method of producing a superhydrophobic surface from PDMS with the use of a simple cast and mold method. This process is rapid, reproducible and yields tunable devices for creating hydrophilic regions on demand. By eliminating the need for chemical alterations to the surface, these superhydrophobic surfaces become much more robust due to the reliance solely on physical geometry at the surface. In addition, the inherent properties of PDMS as the casting material is practical because of its thermal stability, wide usage, and chemical inertness.

### Example 2

This example presents a rapid cast and mold method for creating superhydrophobic surfaces in hard plastics for antibacterial applications. Hard plastics such as PS, PC, and PE are commonly used in commercial applications because they are nonreactive, are biocompatible, and can be manufactured using inexpensive techniques such as roll-to-roll manufacturing. Polydimethylsiloxane (PDMS), a widely used polymer for sealing, coating, and molding, is used as a mold for casting because of its thermal stability and the ability to imprint high aspect ratio and high resolution features. The proposed method is induced without chemical alteration and achieves these superhydrophobic properties through only structural modification. With the initial substrate, this example is able to produce multiple superhydrophobic PDMS casts for molding. Each of these superhydrophobic PDMS substrates is capable of imprinting roughened features into the aforementioned hard plastics, creating a substantial number of superhydrophobic hard plastics from one initial PDMS substrate. The final superhydrophobic hard plastics utilize non-wetting properties to induce antibacterial effects, which could be highly beneficial for commercial application.

The phenomenon of superhydrophobicity is explained in part by a triad of equations centered upon the contact of water with the surface. The surface tension created between water and a surface can be calculated using Young's equation where the three interfaces, solid-liquid (λ_{SV}), solid-vapor (λ_{SL}), and liquid-vapor (λ_{LV}), describe the material's resulting water CA (θ_{Y}) during thermodynamic equilibrium (1).

λ_{SV}−λ_{SL}−λ_{LV} cos θ_{Y}=0 (1)

In particular, as the solid-liquid surface tension increases, the CA increases due to less physical contact. Further analysis of wetting can be performed with Wenzel's theory where the roughness factor (r), determined by a ratio of the geometric surface to the apparent surface, is directly associated with the change in CA (θ_{W}) of the roughened surface (2).

cos θ_{W}=r cos θ_{Y} (2)

In more general terms, this equation explains the ability to increase hydrophobicity on hydrophobic surfaces and increase hydrophilicity on hydrophilic surfaces merely through roughening the surface. However, another model was developed by Cassie and Baxter in which water can only contact the peaks of the roughened surface versus wetting the entire surface in the Wenzel model. This occurs due to the formation of air pockets between the water and surface, decreasing the contact between the solid and liquid phases. For multi-scale (nano to micro) roughness substrates such as the lotus leaf, the Cassie-Baxter model better predicts the equilibrium state. Here, the CA on the roughened surface (θ_{C}) is additionally described by the fraction of the droplet directly in contact with the solid surface (Φ) (3).

cos θ_{C}=Φ cos θ_{Y}+Φ−1 (3)

The increase in solid-liquid surface tension is the primary key to creating superhydrophobicity or the lotus effect.

Superhydrophobicity is achieved when the CA exceeds 150° and the SA is reduced to less than 10°. The high surface tension, minimal surface contact, and ease of movement exhibited by water on superhydrophobic surfaces can be attributed to the presence of multiscale structures. Cheng et al. demonstrated the importance of these features on the lotus leaf by removing the nanostructures which resulted in a decrease in water contact angle. Furthermore, surfaces must be inherently hydrophobic and have a low surface energy to become superhydrophobic when structurally modified.

Thus, leveraging these superhydrophobic surfaces for antibacterial applications is feasible. Due to the minimal solid-liquid contact, the inherently low surface energy of the material, and low SA of the substrate, bacteria prefer to remain in solution rather than adhere to the surface. When a droplet containing bacteria contacts a superhydrophobic surface, there is minimal contact where the bacteria can adhere to the surface. Additionally, in this low contact area there is low surface energy which allows only weak interactions between the surface and bacteria, preventing bacterial adhesion. Since the superhydrophobic surface also has a low SA, bacteria easily slide off the surface when tilted and do not adhere to the surface. Privett et al. even show that structural modification dominates over chemically modified hydrophobic surfaces such as fluorination for antibacterial properties. With solely a structural modification, a superhydrophobic surface will repel bacteria in solution rather than kill them, negating the potential for resistance as would occur due to chemical reagents.

### Materials and Methods

### Structurally Modified Superhydrophobic Surfaces

By utilizing a novel shrink method, superhydrophobic hard plastics were created from a PDMS mold and shrink film, pre-stressed polyolefin (PO). PO (Sealed Air) was first pretreated with oxygen plasma (SPI Supplies) for 30 seconds to temporarily increase the surface energy for better adhesion and was then sputter coated (Quorom) with 60 nm of silver and 60 nm of gold.

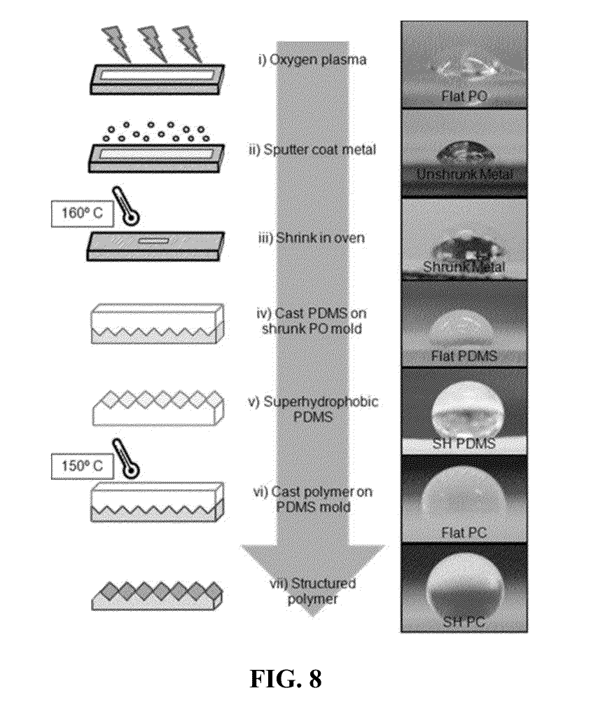

After the bimetallic coating, the PO film was heated to 160° C., causing the PO to shrink. While the PO shrinks due to heating, the metallic films at the surface buckle and fold, creating extremely rough, high-aspect, and multiscale structures. PDMS (Dow Corning Co.) is used to cast these features into a thermally and mechanically stable medium. These features are further transferred into the hard plastics PS (Grafix Plastics), PC (McMaster-Carr), and PE (McMaster-Carr). To produce structurally modified PS, pre-stressed PS was heated to 135° C. to fully shrink the polymer and then casted to the superhydrophobic PDMS mold by applying uniform pressure and heat at 150° C. The PC and PE were produced using the same casting technique at 150° C. FIG. 8 depicts a brief process flow of this fabrication method paired with CA images for each step.

FIG. 8 shows a process flow of the superhydrophobic substrates formed from shrink film paired with their respective CA. (i) PO film is plasma treated with oxygen for 30 seconds (ii) Treated PO film is sputter coated with 60 nm of silver and 60 nm of gold (iii) PO film is shrunk at 160° C. to induce buckling and folding (iv) PDMS is poured over shrunk PO film for casting (paired photo features flat PDMS) (v) Superhydrophobic PDMS cast is removed from shrunk PO (vi) Hard plastics are casted into superhydrophobic PDMS mold by applying pressure and heat (paired photo features flat PC) (vii) Superhydrophobic PC casted from superhydrophobic PDMS.

The superhydrophobic properties of the structurally modified substrates and the original flat substrates were characterized with CA and SA measurements. A contact angle meter (Drop Shape Analysis System DSA100, KRUSS) was used to measure the CA of initial PDMS molds. Further CA measurements were taken with a drop analysis program on PS, PC, and PE. The SA measurements were performed using a tool clamp with a 90° rotational arm.

### Antibacterial Surfaces

Antibacterial testing was performed on equally sized PS, PC, and PE samples for both flat and superhydrophobic substrates using DH5-α gram-negative E. coli. E. coli was inoculated in 10 mL of Luria Broth (LB) (Difco) overnight in an air bath shaker (Environ Shaker) at 37° C. and 300 rpm to reach the exponential growth phase. The bacteria was then diluted 1000× or 10,000× in LB. Using the spread plate method, plating concentrations were determined as 10⁵ colony forming units (CFU)/mL for PS and PC and 2.5×10⁴CFU/mL for PE.

For testing antibacterial properties, 10 μL of bacterial solution was placed on the surface of each substrate. Substrates were tilted at 90° to allow bacterial solution to roll off, if possible. Subsequently, samples were either rinsed with 50 μL of sterile phosphate buffered saline (PBS) or not rinsed. The substrates were then placed face-down in agar (Fisher Scientific) plates to transfer residual bacteria. 50 μL of PBS was added to the agar dish to aid in spreading, and bacteria was spread using a sterile glass loop and a turntable per the spread plate method. 10 μL of bacterial solution was added directly to the control agar plates along with 50 μL of sterile PBS for performing the spread plate method. The agar plates were incubated for 24 hours at 37° C. in a humidified incubator (VWR Scientific Products). Images were taken after 24 hours, and CFU counts were performed to compare bacterial growth.

### Results

### Structurally Modified Superhydrophobic Surfaces

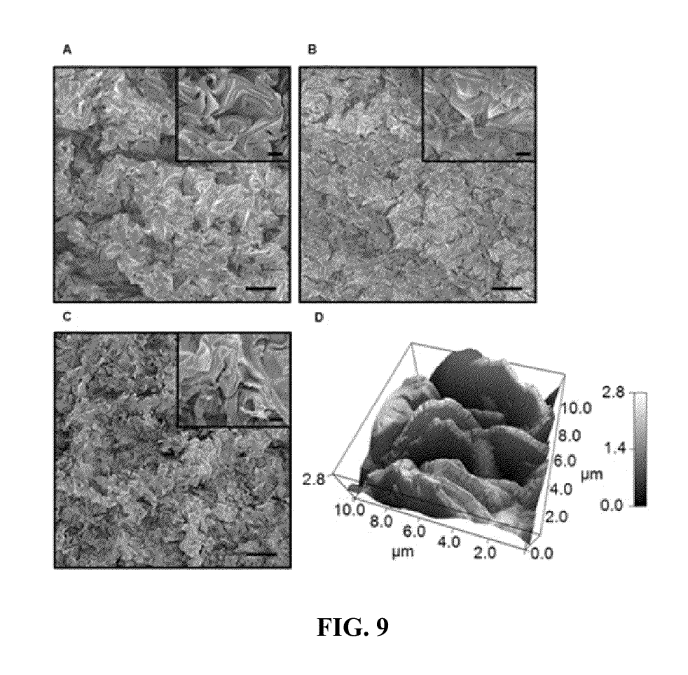

The heterogeneous nano- and microstructures of the metal, PDMS, and PS were analyzed using a scanning electron microscope (SEM) (Hitachi S-4700-2 FES) shown in FIG. 9A-C. The roughness from the shrunk, bimetallic PO mold is translated directly into the PDMS and subsequently into the PS, PC, and PE. Nanostructures can be seen on the surface of the microstructures, leading to the enhanced hydrophobicity explained by the Cassie-Baxter theory. Further visualization of morphology and height was achieved using Atomic Force Microscopy (AFM) (Asylum MPF3D), shown in FIG. 9D, displaying a three dimensional view of the shrunk, bimetallic PO mold with a heterogeneous microstructure height range of 2.8 μm and a root mean square (RMS) value of 700 nm.

FIG. 9A-D show top down SEM images and AFM of the structurally modified surfaces' multiscale structures taken. Features are shown in (A) shrunk, bimetallic PO, (B) transferred in PDMS, and (C) imprinted in PS from PDMS. Scale bar is 10 μm for the large SEM images and 2 μm for the insets. (D) AFM 3D image of the morphology and height profile.

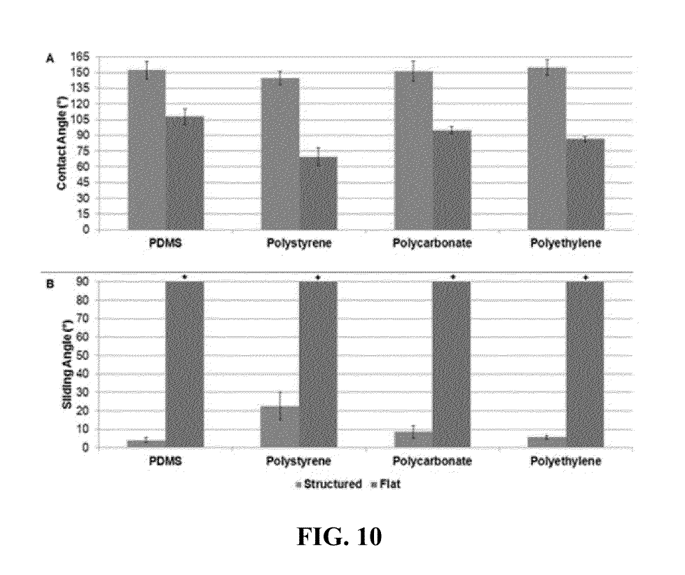

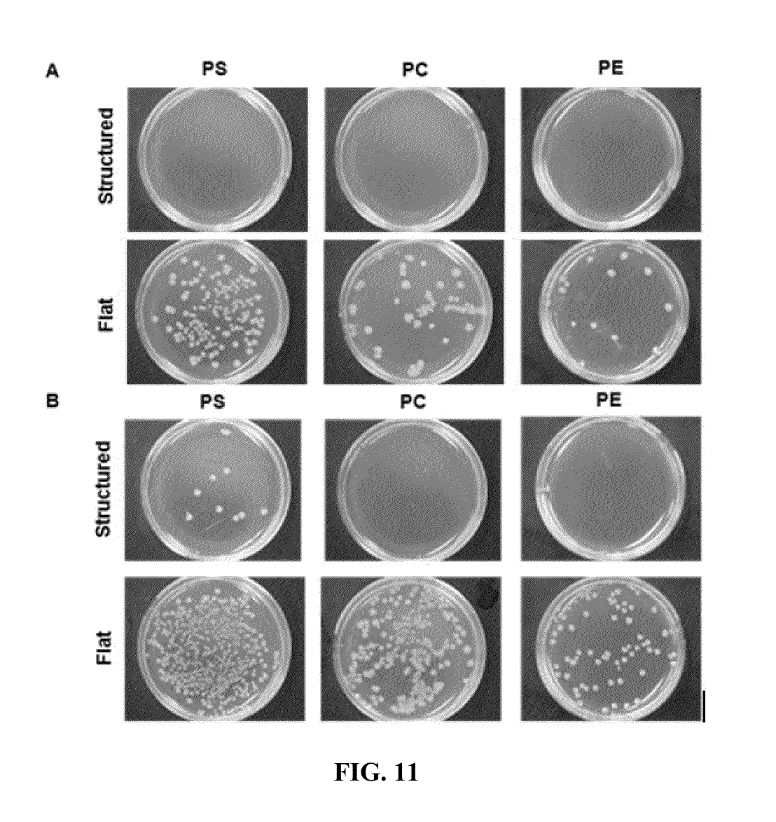

CAs averaged above 150° with a maximum of 167° measured with the KRUSS system, and the average SA was below 5° with a minimum of less than 2° in PDMS, as shown in FIG. 10. PC and PE yielded similarly high CAs and low SAs indicative of superhydrophobicity. PS produced slightly lower CAs and higher SAs but showed hydrophobic enhancement from its flat comparison. FIG. 3A-B include graphs depicting CA and SA for the structurally modified surfaces compared to flat. (A) Contact angle measurements of structurally modified and flat PDMS, PS, PC, and PE. (B) Sliding angle measurements of structurally modified and flat PDMS, PS, PC, and PE.+ represents measurements >90°.

Over the course of three casts from the shrunk, bimetallic PO to PDMS, the CA remained consistently above 150°. In addition, casting PS, PC, or PE from a single PDMS mold has yielded superhydrophobic substrates for more than 30 casts. The thermal stability of the superhydrophobicity in PDMS molds was also investigated and remained stable across a range of heat exposure from 25-100° C. PDMS samples were placed on a hotplate at 10° C. intervals and allowed to acclimatize to the indicated temperature over the course of 5 minutes with a 5 μL water droplet until CA was taken. It was observed that the low SA of superhydrophobic PDMS allows the water droplet to easily roll off the surface.

Calculation of the solid fraction (Φ) from the Cassie-Baxter equation (3) can be calculated using the average flat CA (Θy) and the average structurally modified CA (Θc) for each surface (4).

Φ=(cos θ_{C}+1)/(cos θ_{Y}+1) (4)

The solid fraction Φ is a ratio of the properties of the structured surface to the flat surface. Since all structures are imprinted from the same initial metal PO mold to the polymers, each polymer would theoretically have the same solid fraction Φ. However, the initial Θy is different for each polymer due to intrinsic chemical differences, causing variation in Φ between materials. Table 1 shows calculated values of Φ for our roughened substrates. The low values are similar to the findings of Zhu et al. whose calculated Φ was typically less than 0.1, indicating a highly structured surface. As apparent from equations 3 and 4, as Φ approaches 0, Θc approaches 180°.

TABLE 1
Calculated values of the solid fraction (Φ) were found using the
average flat CA (Θy) and the average structurally modified CA (Θc).
A low value of Φ represents minimal water contact with the surface.

| Material | Θc (°) | Θy (°) | Φ |
|---|---|---|---|
| PDMS | 152 | 108 | .17 |
| PS | 145 | 70 | .14 |
| PC | 151 | 95 | .14 |
| PE | 155 | 87 | .09 |

### Antibacterial Surfaces

Superhydrophobic surfaces exhibit a significantly reduced amount of bacterial growth over flat surfaces, as shown in FIG. 11. Control agar plates of PS and PC had 100,100 CFUs, and PE had 25,800 CFUs for all conditions. Rinsed superhydrophobic surfaces yielded <100 CFUs for PS and PE, and no bacteria was observed on rinsed superhydrophobic PC (Table 2).

As shown in FIG. 11, PS, PC, and PE structured and flat substrates were contaminated with a bacteria solution and either rinsed or not rinsed. The resulting bacterial growth can be observed in each plate in the form of colonies following 24 hour incubation. (A) Substrates were rinsed with 50 μL of PBS after bacteria solution was deposited on the surface. (B) Substrates were not rinsed.

A small fraction (<0.1%) of bacteria was retained from the initial droplet on all rinsed superhydrophobic samples. The flat rinsed surfaces had much higher CFU counts where 10% of the initial number of cells placed on the flat surfaces was transferred to the agar plates even after rinsing. The no rinse superhydrophobic surfaces were also effective at preventing bacterial adhesion with only ˜2% of the original number of cells plated in the final CFU count. Not rinsed flat surfaces had ˜34% of the original number of bacteria plated. Note that all samples experienced a loss of bacteria due to gravity during the tilting step of the experiment.

With the cast and mold method, this example induced superhydrophobic properties on PDMS, PS, PC, and PE. The bimetallic layer deposited on the preshrunk PO mold provided the initial necessary mismatch in stiffness during the shrinking process to create highly structured features after complete shrinking. When casted with PDMS, the bimetallic, shrunk PO mold transfers its physical shape, producing heterogeneous roughening on the PDMS surface and enhancing its natural hydrophobic properties. PDMS was used to imprint these features in PS, PC, and PE to yield similar heterogeneous rough structures and superhydrophobic properties.

The consistency of this method is due in part to the natural properties of PDMS, PS, PC, and PE as well as the method of our design. With the cast and mold method, the surface of the polymer becomes superhydrophobic due to the highly intercut structures passed on from mold to cast. PDMS serves as the ideal medium to transfer these structures into the hard plastics because of its pliability yet high thermal stability. However, it was found that higher levels of hydrophobicity were achieved through structural modification of initially more hydrophobic polymers (PC and PE) versus initially hydrophilic polymers (PS). While roughening of the PS surface did increase hydrophobicity, it did not achieve characteristic values to be truly superhydrophobic because of its naturally more hydrophilic state when flat. Nevertheless, antibacterial testing for the structurally modified PS was favorable over the flat PS in both the rinse and no rinse conditions but to a lesser degree than PC and PE. Thus, for optimal hydrophobic and antibacterial surfaces, beginning with a more hydrophobic polymer seems favorable.

TABLE 2
CFU counts for structured versus flat surfaces.

| | | | | | % Adherence |
|---|---|---|---|---|---|
| | | | | | (Average of |
| | | | | | Experiment/ |
| Condition | Substrate | PS | PC | PE | Control) |
| Rinse | Structured | 70 | 0 | 30 | <.1% |
| | Flat | 15,700 | 10,700 | 900 | 10% |
| No Rinse | Structured | 2,100 | 1,500 | 300 | 2% |
| | Flat | >36,900* | 30,700 | 8,900 | >34%* |
| Control | Control | 100,100 | 100,100 | 25,800 | 100% |

*One agar plate yielded a condensed area of cell growth, hindering the ability to count individual colonies. Thus, this value is an underestimate.

Superhydrophobic surfaces are antibacterial because of their minimal solid-liquid contact at the surface, weak surface interactions with bacteria, and low SA. As a result of these properties, it is energetically favorable for the bacteria to remain in solution and to roll off the surface when tilted rather than adhere to the superhydrophobic surface. This self-cleaning principle is the key to antibacterial properties of superhydrophobic surfaces. Dirt and bacteria adhere to water better than the surface and are, therefore, cleaned easily. Since this antibacterial design is purely structural, a product with permanent features can be manufactured for everyday use with minimal maintenance for the customer.

This fabrication method has the potential for further development at a larger manufacturing scale and into additional materials. The PO polymer used to create the initial mold, in addition to the resulting molded hard plastics, are compatible with roll-to-roll manufacturing methods. While we demonstrate the ability to create superhydrophobic characteristics by transferring these features into only three hard plastics, this method is applicable to virtually any inherently hydrophobic plastic.

This example presented a new method of producing a superhydrophobic surface from PO by simply molding features into PDMS and again into the hard plastics PS, PC, and PE. This process is rapid, reproducible, and yields antibacterial surfaces on these hard plastics. By eliminating the need for chemical alterations to the surface, these superhydrophobic surfaces become much more robust due to the reliance solely on physical geometry at the surface. In addition, using PDMS as a means to transfer the superhydrophobic nano- and microscale structures presents the opportunity to produce a substantial number of superhydrophobic hard plastics from a single mold. Finally, this technique is compatible with roll-to-roll manufacturing and scale-up production methods due to the use of the polymers PO, PS, PC, and PE, making this process potentially accessible for many different applications.

The disclosure illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the disclosure claimed.

Thus, it should be understood that although the present disclosure has been specifically disclosed by preferred embodiments and optional features, modification, improvement and variation of the disclosure embodied therein herein disclosed may be resorted to by those skilled in the art, and that such modifications, improvements and variations are considered to be within the scope of this disclosure. The materials, methods, and examples provided here are representative of preferred embodiments, are exemplary, and are not intended as limitations on the scope of the disclosure.

The disclosure has been described broadly and generically herein. Each of the narrower species and subgeneric groupings falling within the generic disclosure also form part of the disclosure. This includes the generic description of the disclosure with a proviso or negative limitation removing any subject matter from the genus, regardless of whether or not the excised material is specifically recited herein.

In addition, where features or aspects of the disclosure are described in terms of Markush groups, those skilled in the art will recognize that the disclosure is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

1. A method for preparing a mold for making a superhydrophobic surface, comprising contacting a surface of a thermoplastic material with a plasma;
coating the surface with a metal; and
heating the thermoplastic material to shrink the surface such that the coated metal forms a texture on the thermoplastic material, thereby making the mold.

2. The method of claim 1, further comprising creating a mirrored texture on a surface of a hydrophobic material, using the textured metal surface of the thermoplastic material as a mold.

3. The method of claim 1, wherein the plasma is one or more of oxygen plasma, helium plasma, hydrogen plasma.

4. The method of claim 1, wherein the contacting with the plasma is from about 10 seconds to about 2 minutes in duration.

5. The method of claim 2, wherein the contacting with the plasma is from about 15 seconds to about 60 seconds in duration.

6. The method of claim 1, wherein the metal comprises one or more of silver, gold or a combination of gold and silver.

7. The method of claim 1, wherein the coating is from about 10 nm to about 200 nm in thickness.

8. The method of claim 1, wherein the coating is from about 30 nm to about 90 nm.

9. The method of claim 1, wherein the heating is carried out in a temperature from about 100° C. to about 200° C.

10. The method of claim 9, wherein the heating is carried out at from about 100° C. to about 120° C. for about 3-10 minutes followed by heating at about 150° C. to about 170° C. for about 3-10 minutes.

11. The method of claim 1, wherein the surface of the thermoplastic material is shrunk by at least 60%.

12. The method of claim 11, wherein the texture has an average height from about 2 μm to about 4 μm.

13. The method of claim 1, wherein the thermoplastic material comprises a high molecular weight polymer, polyolefin, polyethylene, acrylonitrile butadiene styrene (ABS), acrylic, celluloid, cellulose acetate, ethylene-vinyl acetate (EVA), ethylene vinyl alcohol (EVAL), fluoroplastics (PTFEs, including FEP, PFA, CTFE, ECTFE, ETFE), ionomers kydex, a trademarked acrylic/PVC alloy, liquid crystal polymer (LCP), polyacetal (POM or Acetal), polyacrylates (Acrylic), polyacrylonitrile (PAN or Acrylonitrile), polyamide (PA or Nylon), polyamide-imide (PAI), polyaryletherketone (PAEK or Ketone), polybutadiene (PBD), polybutylene (PB), polybutylene terephthalate (PBT), polyethylene terephthalate (PET), Polycyclohexylene Dimethylene Terephthalate (PCT), polycarbonate (PC), polyhydroxyalkanoates (PHAs), polyketone (PK), polyester polyethylene (PE), polyetheretherketone (PEEK), polyetherimide (PEI), polyethersulfone (PES), polysulfone polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyvinyl chloride (PVC), polyvinylidene chloride (PVDC) or spectralon.

14. The method of claim 1, wherein the thermoplastic material comprises polyolefin.

15. The method of claim 2, wherein the hydrophobic material comprises polydimethylsiloxane (PDMS).

16. The method of claim 2, further comprising subjecting a portion of the surface of the hydrophoblic material to a plasma treatment, such that the portion becomes temporally hydrophilic.

17. A superhydrophobic surface prepared by the method of claim 2.

18. The superhydrophobic surface of claim 17, having an average water contact angles above about 120° and an average water sliding angle below about 10°.

19. A superhydrophobic surface comprising a hydrophilic portion prepared by the method of claim 17.
